(19) United States
(12) Patent Application Publication
(10) Pub. No.: US 2010/0282557 A1
(43) Pub. Date: Nov. 11, 2010

(54) MAINS POWER SUPPLY EQUIPMENT FOR RUBBER-TIRED PORT CONTAINER GANTRY CRANES

(76) Inventors: Qinfen He, Shanghai (CN); Quifan Bao, Shanghai (CN)

Correspondence Address: BANNER & WITCOFF, LTD., 1100 13th STREET, N.W., SUITE 1200, WASHINGTON, DC, 20005-4051, US

(21) Appl. No.: 12/446,030

(22) PCT Filed: Sep. 10, 2007
(86) PCT No.: PCT/CN2007/002675

§ 371 Date: Apr. 17, 2009

(30) Foreign Application Priority Data
Sep. 18, 2006 (CN) 200620045914.0

(51) Int. Cl. B66C 13/12; H02G 7/00; B60L 5/08

(52) U.S. Cl. 191/33 R; 191/59

(57) ABSTRACT

The invention relates to a mains power supply equipment for rubber-tired port container gantry cranes comprising a trolley line connected to a power supply network and a power system of the rubber-tired gantry crane, wherein the trolley line is erected fixedly and high in the air above the rubber-tired gantry crane, the position of the trolley line is higher than that of the container lorry, and on the trolley line is mounted movably a trolley shoe contacted electrically with the trolley line, and connected with the power system of the rubber-tired gantry crane through a wire. With such a mains power supply equipment for rubber-tired port container gantry cranes according to the present invention, the rubber-tired gantry crane can be powered by the power supply network to handle containers; the cart of the rubber-tired container gantry crane is not required specially to move straightly; it is very convenient to erect on the clearance or the open space beside the port container storage yard, and has no special requirements to the site; it also facilitates the rubber-tired gantry crane greatly in transferring to another working lane; and it is economical and practical, has a simple structure and a relatively low cost, is convenient to construct, flexible and convenient to operate, safe and reliable, has an extensive application scope, improves the equipment in energy saving, consumption reduction and pollution reduction.

### TECHNOLOGY FIELD

The present invention relates to the field of handling port containers, especially to the field of power supply systems for container hoisting equipments, in particular to a mains power supply equipment for rubber-tired port container gantry cranes.

### BACKGROUND TECHNOLOGY

In the modern society, with the increasingly closer relation and exchange of the economic trade, the port transport industry has developed vigorously. However, in the existing technology, the hoisting machinery generally used in handling containers at the port container terminal storage yard (Yard Container Crane for short) has mainly two types:

(1) Rail-mounted Gantry Crane—The rail-mounted gantry crane runs on a fixed rail, and the power is supplied through the power supply network, thus the crane saves energy, has no noise, no exhaust emission, a high reliability and a small maintenance and repair workload, but its fatal disadvantage is that it can not transfer to another working lane (from one container working lane to another container working lane) on the container yard, which results in one time high investment and a low use rate, so major ports seldom use this type of cranes.

(2) Rubber-tired Gantry Crane—The rubber-tired gantry crane is powered by a diesel engine, and transfers freely to another working lane on the container yard, but the huge diesel generator has a low efficiency, big reactive power consumption, large noise and much smoking dust polluted the environment seriously. Especially in the past few years, due to the soaring fuel price and the increased requirements to energy saving and environmental protection, the shortcomings and weaknesses of this crane itself have become more and more apparent, and bring much inconvenience to people's normal work.

### DISCLOSURE OF THE INVENTION

The object of the present invention is to overcome the defects of the prior arts mentioned above to provide a mains power supply equipment for rubber-tired port container gantry cranes which can supply power by utilizing the power supply network effectively, is economical and practical, has a simple structure and a relatively low cost, is flexible and convenient to operate, safe and stable, and has an extensive application scope.

In order to realize the above object, the mains power supply equipment for rubber-tired port container gantry cranes of the present invention has the following structure:

The mains power supply equipment for rubber-tired port container gantry cranes comprises a trolley line connected to a power supply network and a power system of the rubber-tired gantry crane, and its features are that: the trolley line is erected fixedly and high in the air above the rubber-tired gantry crane, the position of the trolley line is higher than that of the container lorry, and on the trolley line is mounted movably a trolley shoe contacted electrically with the trolley line, and connected with the power system of the rubber-tired gantry crane through a wire.

The trolley shoe of the mains power supply equipment for rubber-tired port container gantry cranes is a slide-wire conductive instrument sliding freely along the elongation direction of the trolley line under an external force, and sheathed movably on the trolley line.

The trolley line of the mains power supply equipment for rubber-tired port container gantry cranes can be erected fixedly and bridgingly in the air above the rubber-tired gantry crane through at least one telegraph pole or at least one wire tower.

The erected span between two poles and/or towers of the trolley line of the mains power supply equipment for rubber-tired port container gantry cranes is between 10 m-300 m.

The wire of the mains power supply equipment for rubber-tired port container gantry cranes connected with the trolley shoe can be connected with the power system of the rubber-tired gantry crane through a power switch, a relay, a contactor, a filter or a transformer.

With the mains power supply equipment for rubber-tired port container gantry cranes according to the present invention, for the trolley line is erected high in the air above the port and connected with the power system of the rubber-tired gantry crane through the trolley shoe mounted on the trolley line and sliding freely along its elongation direction, the rubber-tired gantry crane can be powered by the power supply network when needed; at the same time, for the trolley line and the trolley shoe have a certain degree of flexibility, the cart of the rubber-tired container gantry crane can move like before, and is not required specially to move straightly; not only that, the trolley line is fixed and supported by the telegraph poles or the wire towers to achieve the high erection in the air, the distance between two wire towers can be relatively long, generally above 10 m, up to tens or even several hundred meters, therefore, it is very convenient to arrange the telegraph poles or the wire towers on the clearance or the open space beside the port container storage yard to avoid the special requirements of the site; and the trolley shoe can be separated from or mounted on the power supply trolley line manually or automatically, which facilitates the rubber-tired gantry crane greatly in transferring to another working lane; in addition, the power supply trolley line and the telegraph poles or the wire towers are used to supply the electric power, and they are common materials, economical and practical, thus the present invention has a simple structure and a relatively low cost, is convenient to construct, flexible and convenient to operate, safe and reliable, has an extensive application scope, particularly suitable for use at the port terminals, and can greatly improve important performance indicators of the existing equipment such as energy saving, consumption reduction, pollution reduction and so on.

### DESCRIPTION OF THE FIGURES

FIG. 1 is a schematic view of the system structure of the mains power supply equipment for rubber-tired port container gantry cranes according to the present invention.

### PREFERRED EMBODIMENTS OF THE INVENTION

In order to understand the technical content of the present invention clearly, the present invention is further exemplified by reference to the following examples.

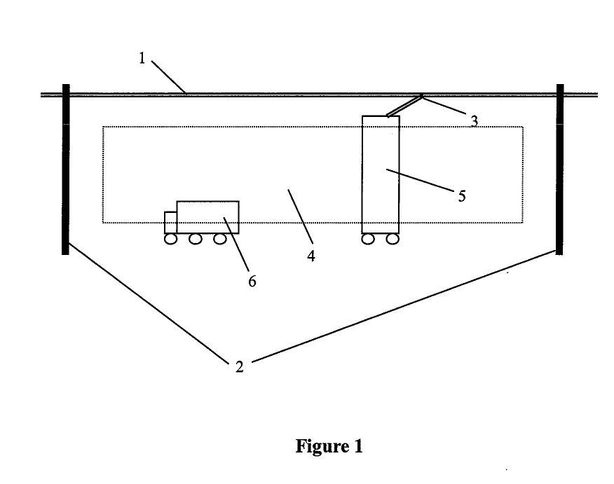

Please refer to FIG. 1, and the mains power supply equipment for rubber-tired port container gantry cranes comprises a trolley line 1 connected to a power supply network and a power system of the rubber-tired gantry crane 5, wherein the trolley line 1 is erected fixedly and high in the air above the rubber-tired gantry crane 5, in one embodiment of the present invention, the trolley line 1 can be erected fixedly and bridgingly in the air above the rubber-tired gantry crane 5 through at least one telegraph pole or at least one wire tower 2, and the erected span between two poles and/or towers of the trolley line 1 is between 10 m-300 m, thus it is very convenient to select the clearance or the open space beside the port container storage yard 4 to erect the telegraph poles or the wire towers 2; the position of the trolley line 1 is higher than that of the container lorry 6, and slightly higher than that of the rubber-tired gantry crane 5, and on the trolley line 1 is mounted movably a trolley shoe 3 contacted electrically with the trolley line 1, the trolley shoe 3 is a slide-wire conductive instrument 3 sliding freely along the elongation direction of the trolley line under an external force, sheathed movably on the trolley line 1, and connected with the power system of the rubber-tired gantry crane 5 through a wire, and even a power switch, a relay, a contactor, a filter or a transformer.

In the actual application, in the power supply equipment of the present invention, the electric power is supplied through the trolley line 1 (having a certain degree of flexibility), and the trolley line 1 is erected high in the air and slightly higher than the rubber-tired gantry crane 5 generally to avoid collision, and of course higher than the container lorry 6, so as to avoid the safety problem caused by erecting the trolley line 1 and other conductive power suppliers in the low air, or erecting or laying them on the ground, even the collision and abrasion problem caused by the moving lorry and the moving crane with the trolley line 1 or other power suppliers, the trolley line 1 is fixed and supported by the telegraph poles or the wire towers 2 to achieve the high erection in the air, the distance between two wire towers 2 can be relatively long, generally above 10 m, up to tens or even several hundred meters, therefore, it is very convenient to arrange the telegraph poles or the wire towers on the clearance or the open space beside the port container storage yard 4.

At the same time, the trolley line 1 plays the role of the slide-wire, and the slide-wire conductive instrument 3 can slide freely along the slide-wire under an external force, and simultaneously guide the electric power out from the trolley line 1 continuously; furthermore, the slide-wire conductive instrument 3 can be separated from or mounted on the power supply trolley line 1 manually or automatically.

The electric power guided out by the slide-wire conductive instrument 3 is connected with the power system of the rubber-tired gantry crane 5, and also they can be connected through a power switch, a relay, a contactor, a filter, a transformer or the like, if necessary, the rubber-tired gantry crane 5 can be powered directly by the power supply network.

With the above-mentioned mains power supply equipment for rubber-tired port container gantry cranes, for the trolley line 1 is erected high in the air above the port and connected with the power system of the rubber-tired gantry crane 5 through the trolley shoe 3 mounted on the trolley line 1 and sliding freely along its elongation direction, the rubber-tired gantry crane 5 can be powered by the power supply network when needed; at the same time, for the trolley line 1 and the trolley shoe 3 have a certain degree of flexibility, the cart of the rubber-tired container gantry crane 5 can move like before, and is not required specially to move straightly; not only that, the trolley line 1 is fixed and supported by the telegraph poles or the wire towers 2 to achieve the high erection in the air, the distance between two wire towers 2 can be relatively long, generally above 10 m, up to tens or even several hundred meters, therefore, it is very convenient to arrange the telegraph poles or the wire towers 2 on the clearance or the open space beside the port container storage yard 4 to avoid the special requirements of the site; and the trolley shoe 3 can be separated from or mounted on the power supply trolley line 1 manually or automatically, which facilitates the rubber-tired gantry crane 5 greatly in transferring to another working lane; in addition, the power supply trolley line 1 and the telegraph poles or the wire towers 2 are used to supply the electric power, and they are common materials, economical and practical, thus the present invention has a simple structure and a relatively low cost, is convenient to construct, flexible and convenient to operate, safe and reliable, has an extensive application scope, particularly suitable for use at the port terminals, and can greatly improve important performance indicators of the existing equipment such as energy saving, consumption reduction, pollution reduction and so on.

In the present specification, the present invention has been described according to the particular embodiments. But it is obvious that these embodiments can be modified or changed without departure from the spirit and scope of the present invention. Therefore, the specification and drawings described above are exemplary only and not intended to be limiting.

I claim:

1. A mains power supply equipment for rubber-tired port container gantry cranes, comprising a trolley line connected to a power supply network and a power system of the rubber-tired gantry crane, characterized in that, the trolley line is erected fixedly and high in the air above the rubber-tired gantry crane, and the position of the trolley line is higher than that of the container lorry, on the trolley line is mounted movably a trolley shoe contacted electrically with the trolley line, and connected with the power system of the rubber-tired gantry crane through a wire.

2. The mains power supply equipment for rubber-tired port container gantry cranes according to claim 1, characterized in that, the trolley shoe is a slide-wire conductive instrument sliding freely along the elongation direction of the trolley line under an external force, and sheathed movably on the trolley line.

3. The mains power supply equipment for rubber-tired port container gantry cranes according to claim 1, characterized in that, the trolley line is erected fixedly and bridgingly in the air above the rubber-tired gantry crane through at least one telegraph pole or at least one wire tower.

4. The mains power supply equipment for rubber-tired port container gantry cranes according to claim 3, characterized in that, the erected span between two poles and/or towers of the trolley line is between 10 m-300 m.

5. The mains power supply equipment for rubber-tired port container gantry cranes according to any one of claims 1-4, characterized in that, the wire connected with the trolley shoe can be connected with the power system of the rubber-tired gantry crane through a power switch, a relay, a contactor, a filter or a transformer.
